(19) United States
(12) Patent Application Publication
(10) Pub. No.: US 2009/0090466 A1
(43) Pub. Date: Apr. 9, 2009

(54) Process for the Attachment of a Volatizable Active Agent To a Solid Support Material and for the Controlled Release of the Agent To the Environment

(76) Inventors: Hans-Jurgen Huppert, Leipzig (DE); Colin Berrido, Bagshot (GB)

Correspondence Address: COLLARD & ROE, P.C., 1077 NORTHERN BOULEVARD, ROSLYN, NY, 11576, US

(21) Appl. No.: 11/989,346

(22) PCT Filed: Jun. 9, 2006
(86) PCT No.: PCT/EP2006/005527

§ 371 Date: Jan. 24, 2008

(30) Foreign Application Priority Data
Jul. 29, 2005 (DE) 10 2005 036 415.2

(51) Int. Cl. B32B 37/12

(52) U.S. Cl. 156/282

(57) ABSTRACT

The invention relates to a method for attaching a volatizable active substance (4) to a supporting material (1) and for the controlled release of this active substance (4) into the surrounding area, during which the volatizable active substance (4) is introduced into a carrier material (2), which is solid at normal temperature and which is melted by heating, and a carrier material/active material melt S is placed in contact at least with a portion of the supporting material (1) having the normal temperature or a lower temperature whereby attaching thereto in the form of a film F, and the volatizable active substance (4) is released in a controlled manner by natural and/or artificial influence of air and/or heat from the carrier material (2) attached in the form of a film F.

The invention is related to a process for the attachment of a volatizable active agent to a solid support material and for the controlled release of the agent to the environment, e.g. for the purposes of scenting, deodorization, disinfection, disinfestation etc. in rooms.

In connection with this invention, the term “agent” shall comprise any actively effective liquid and solid substances such as flavours and fragrances, deodorants, disinfectants, disinfestation agents as well as their compounds or mixtures.

The state of the art comprises a variety of methods for scenting, deodorization, disinfection, disinfestation in rooms by the release of volatizable agents using different types of devices and processes.

DE 10247583 A1, for instance, describes a process for the manufacture of a solid fragrance concentrate where a fragrance liquid at normal temperature is dissolved in a fatty alcohol or fatty alcohol/fatty acid mixture solid at normal temperature and liquefied by heating, and subsequently solidified and formed into a bead-shaped or granular solid fragrance by cooling down. While this fragrance can be easily integrated in solid products to be scented such as powdery detergents and solid soaps, it is difficult to handle for the controlled release of the scent in rooms.

Furthermore, DE 4406581 A1 describes a leaf-shaped scent enhancer which comprises a sheet of filter paper soaked with the liquid fragrance, inserted between two layers of foil by welding or pasting, where at least one of the foil layers is a diffusion-open collagen foil. For scent enhancement, the fragrance leaf formed in this way is arranged in the room to be scented, where the fragrance soaked up by the filter paper evaporates gradually, the fragrance molecules diffuse through the collagen foil and spread in the room as a lasting scent. Thus unpleasant smells in the room may be neutralized. The manufacture of such a fragrance leaf by welding or pasting a sheet of liquid-soaked support material in at least partially diffusion-open foils is however rather complicated and expensive.

DE 19852116 A1 describes a process for the release of fragrances in a room where a carrier gas is passed through a liquid fragrance and the carrier gas becomes enriched with the liquid fragrance and is released into the room. This method requires complex equipment and its application is rather complicated.

Therefore the invention is based on the underlying task of developing a process for the attachment of a volatizable agent to a support material and the controlled release of the agent to the environment, a method that can be implemented with relatively low effort and where the release of the agent is performed in a rather uncomplicated way.

This task is solved by the characterizing features of Claim 1.

Preferred embodiments of the invention form the characterizing features of Sub-Claims 2 to 17.

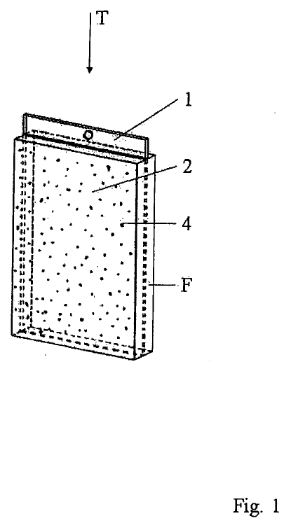

Below the invention will be explained in greater detail based on an embodiment and with reference to FIGS. 1 to 9.

FIG. 1 shows a carrier material solid at normal temperature and formed as a thin film, in which an agent is embedded and which, in accordance to the invention, has been attached to a support material, so that the agent can be released from the carrier material in accordance with the invention;

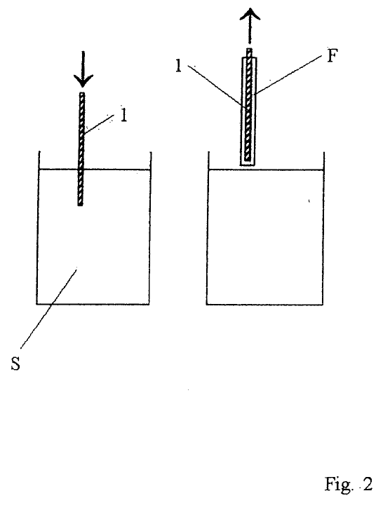

FIG. 2 is a schematic diagram showing how the solid carrier material with the embedded agent is attached to the support material in accordance with the invention by immersing a support material in a melt of carrier material and agent;

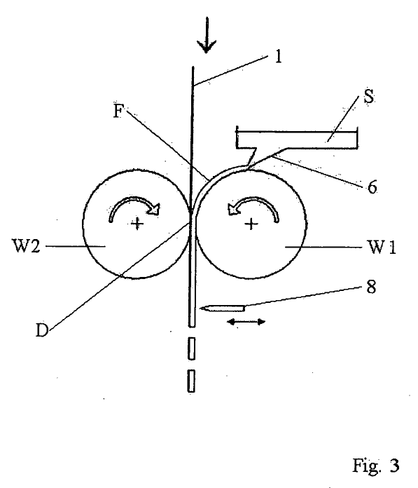

FIG. 3 shows the attachment of the carrier material with embedded agent flowing from a melt bath to a roller and, when passing a gap between this roller and a counter-roller, is rolled onto a support material passing the rollers at the same time;

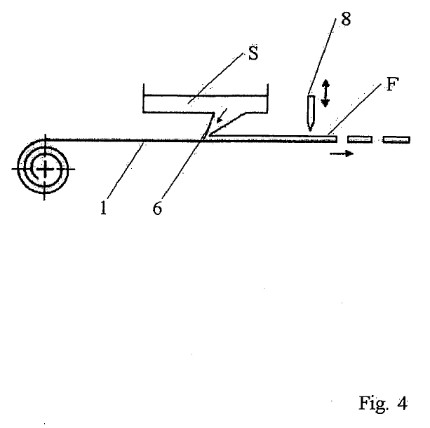

FIG. 4 shows a process similar to the one shown in FIG. 3, where the carrier material liquefied by heating, with the agent embedded in it, is poured as a film onto a support material band passed along the outlet slot, and solidifies as a film;

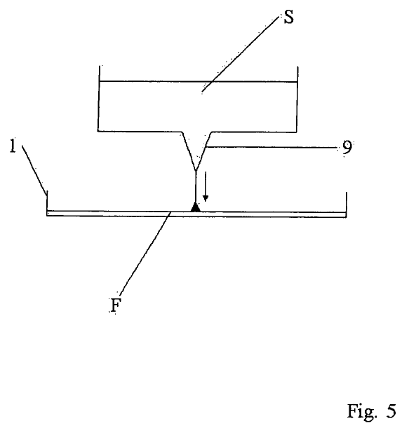

FIG. 5 shows the pouring of the carrier material with the embedded agent for the formation of a film on a pre-formed support material;

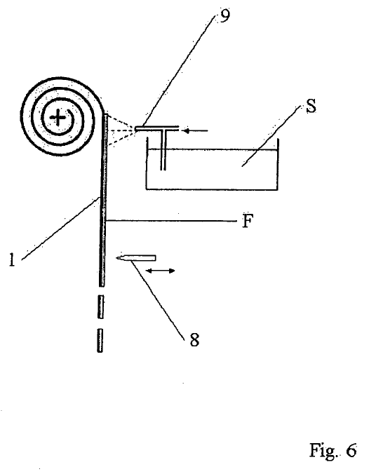

FIG. 6 shows the spraying of liquid carrier material with the embedded agent onto a support material band passing the spray nozzle;

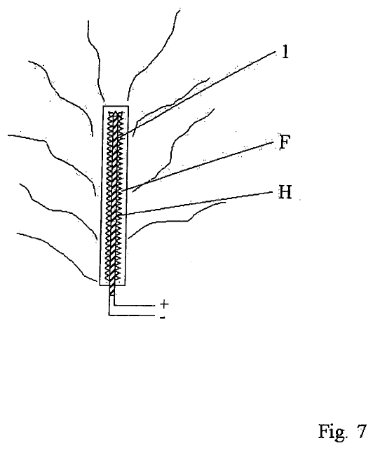

FIG. 7 shows the controllable release of the agent from the carrier material attached to the support material in the form of a film, by electric means within the attached carrier material;

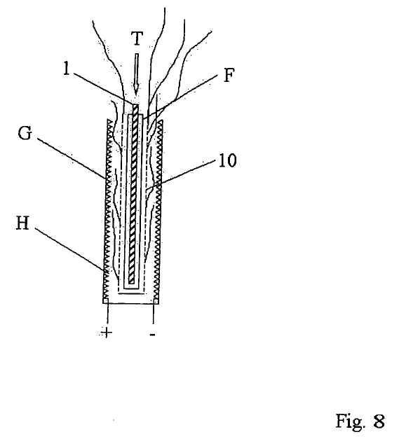

FIG. 8 shows the controlled release of the agent by electric means where the electric heat source is located outside the carrier material film with embedded agent attached to the support material;

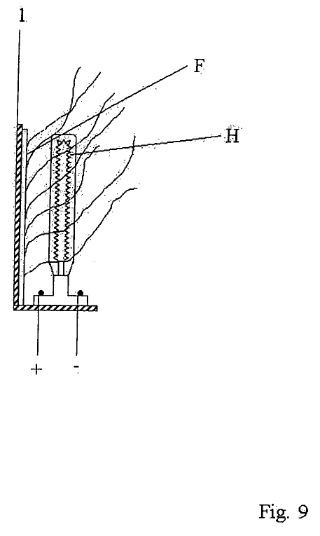

FIG. 9 shows a release of the agent from the carrier material film similar to FIG. 8 brought about by electric heating where the heat source is a light bulb.

FIG. 1 is a schematic diagram showing the attachment of a carrier material 2 with volatizable agent 4 to a solid support material 1 for the purposes of controlled release of the agent 4 to the environment.

The agent 4 is introduced in a well-known way into the melt of a carrier material 2 solid at normal temperature, and the carrier material 2 with the embedded agent 4 is attached to the solid support material in the form of a film F by immersion of a solid support material 1 in a melt bath S consisting of the carrier material 2 and the embedded agent 4. As mentioned in the introduction, the active agent 4 can be any actively effective liquid or solid substance such as a fragrance or flavour, a deodorant, a disinfectant, a disinfestation agent as well as any compound or mixture of these or similar substances.

The carrier material 2 solid at ambient temperature, with the agent 4 embedded therein, is preferably a fatty alcohol or fatty alcohol/fatty acid mixture known from DE 10247583 A1.

The schematic representation in FIG. 2 shows how the attachment of the carrier material 2 with the embedded agent 4 to the support material 1 can be performed in an easy way. A strip of the support material 1 is immersed in a melt bath S, where the carrier material 2, liquefied by heating, with the embedded agent 4, is contained. As shown on the left-hand side of FIG. 2, the support material 1 is immersed in the melt bath S at normal temperature, the result of which is that the liquid carrier material 2 with embedded agent 4 solidifies on the colder surface of the immersed support material 1 as a solid film F and adheres to the strip of support material 1. The right-hand side of FIG. 2 shows how, after pulling out the support material strip from the melt bath S, a film F of carrier material 2 with the embedded agent 4 has formed. The attachment of the carrier material 2 with embedded agent 4 to the support material 1 is by no means restricted to the attachment to a support material strip shown in FIG. 2, rather any type of support material 1 can be provided with a film F of a solid carrier material 2 with embedded agent 4 by immersion in a melt bath S consisting of the liquefied carrier material 2 and agent 4.

Flat materials made of paper, cardboard, plastics, metal, ceramics or glass, fleece or tissue as well as tissue-like products made of textile, glass, ceramics, metal or plastics fibres or laminates from the above materials can be used as support material 1. Also components made by moulding or forming, e.g. injection-moulded components made of plastics are suitable as support material 1.

FIG. 3 shows another embodiment of the process for the attachment of a carrier material 2 with embedded volatizable agent 4 to a support material 1 for the controlled release of the volatizable agent 4 to the environment. FIG. 3 shows, as a schematic diagram, a melt bath S with the molten carrier material 2 and embedded agent 4 contained therein. The melt bath S has an outlet slot 6 guiding the liquid carrier material 2 to the surface of a roller W1. The roller W1 forms, together with a counter roller W2 arranged at the same level and with parallel axes, a passage slot D, through which a band of support material 1 is guided. The roller W1 is cooled the result of which is that a film band F of carrier material 2 with embedded agent 4 forms on the roller surface after outlet slot 6 of the melt bath, conveyed by the roller W1 to the passage slot D and rolled onto the support material band 1 simultaneously passing the rollers. After this attachment of the carrier material 2 with embedded agent 4 to the support material 1, the band is cut into pieces by a cutting device 8. Of course it is also possible to feed liquid carrier material to the counter roller W2 from a melt bath S via an outlet slot 6, and a film F can be formed so that the support material band is coated on both sides.

FIG. 4 shows another embodiment for the attachment of carrier material 2 with embedded volatizable agent 4 to a support material 1. Here a band of support material 1 is directly guided below an outlet slot 6 from melt bath S. The carrier material 2 with embedded agent 4 flows, in the width of outlet slot 6, onto the support material band 1 and solidifies on the support material band 1 having normal temperature, to a film F, and the support material band 1 with the attached film F of carrier material 2 and embedded agent 4 is cut into pieces by a cutting device 8 in the same way as in the embodiment described in FIG. 3.

FIG. 5 shows another embodiment of the process for the attachment of a carrier material 2 with embedded volatizable agent 4 to a support material 1 for the controlled release of the volatizable agent 4 to the environment. In this embodiment, the liquefied carrier material 2 is drained from the melt bath S via an outlet nozzle 9 and poured onto a carrier material body 1. The carrier material 2 with the embedded agent 4 solidifies on the support material body 1 to a film F from which the volatizable agent 4 can subsequently be released to the environment in a controlled way.

FIG. 6 shows another embodiment of the process of the invention, where the attachment of the carrier material 2 with the embedded volatizable agent 4 to a support material 1 is achieved by spraying the melt S onto a band of support material 1 moving along the spray nozzle 9. The droplets of liquefied carrier material 2 with embedded agent 4 hitting the band of support material 1 through spray nozzle 9 cool down on support material 1, which has normal temperature, and form a coherent film F. When further moving the band now consisting of the support material 1 and the attached carrier material 2 with the embedded agent 4, the band is cut into individual pieces by the cutting device 8, from which the volatizable agent can be released in a controlled way under the effect of air and/or heat.

The simplest form of controlled release is achieved by merely arranging the part T shown in FIG. 1 in the room. Depending on the temperature and air circulation existing or generated in the room, the agent 4 embedded in the carrier material 2 is released in a slower or faster way. The term “room” should comprise any type of spatial volume, e.g. a room, a wardrobe, a case, a cardboard or other box etc.

FIG. 7 shows an embodiment of the process where a support material 1 is used together with an electric heating device H arranged thereon. The part T used for this method can be provided with the carrier material 2 and the embedded volatizable agent 4 in the same way as the part T shown in FIG. 1. Either an additional heatable foil is attached to the support material 1, or the electrically heatable foil itself forms the support material 1. In both cases the support material 1, having normal or a lower temperature and shown in FIG. 2, can be immersed in the carrier material—agent melt S and in this way be surrounded with the film F consisting of the carrier material 2 and the volatizable agent 4 embedded therein.

To ensure the controlled release of the agent 4 embedded in carrier material 2, a voltage is applied to the electrical connections marked with + and − in FIG. 7. In this way the heating device H heats up and the agent is released to a greater extent than just by ambient air or heat. Through voltage variation or time-controlled switching on or off of the electrical heating device, the release of agent 4 can be systematically and accurately controlled. Alternating voltage may also be used for heating purposes.

FIG. 8 shows an embodiment of the process where the release of the volatizable agent is achieved by an external heat source. The internal walls of a housing G have been provided with a heating device H consisting of heating foils, heating wires or similar heating elements, and a part T in accordance with FIG. 1 is inserted in the housing at a fixed distance to the heating elements which may be ensured by stationary spacer lattices 10. By applying a voltage to the heating device H, the agent 4 embedded in the carrier material 2 is released in a controlled way. As in the embodiment described in FIG. 7, varying the voltage or time-controlled switching on or off of the heating device H may exactly and systematically control the release. The embodiment in accordance with FIG. 8 also makes it possible to automatically control the switching on or off of the heating elements by a button installed in the housing and by inserting or pulling out the part.

FIG. 9 shows an embodiment with electrical heating where the heating device H is a light bulb. The support material 1 has e.g. an angular form, and the holder of the light bulb is connected with the lower arm of the angle. The arm of the angle pointing upwards is coated with a film F of carrier material 2 with embedded agent 4 on its inner surface pointing towards the light bulb. After the light bulb has been turned on, the heat generated will release the volatizable agent 4 from the carrier material 2. As in the previous embodiments in accordance with FIGS. 7 and 8, the release of the agent 4 can also be exactly and systematically controlled by voltage variation or time-controlled switching on or off of the light bulb.

The heat effect can also be achieved by other, preferably electrical means, e.g. an infrared heat source or a microwave generator.

In all applications, the release of the volatizable agent 4 can be solely or additionally influenced by natural or artificial convection, e.g. by a fan (not shown).

The embodiments shown in FIGS. 1 to 9 and described above are only examples and do not in any way restrict the scope of protection of the invention. The scope of protection of the invention is exclusively determined by the attached Claims.

1-17. (canceled)

18. A process for the attachment of a volatizable active agent (4) to a support material (1) and for the controlled release of the volatizable active agent (4) to the environment, where the volatizable active agent (4) is inserted in a carrier material (2) solid at normal temperature and molten by heating and the carrier material-agent melt (S) is brought into contact with at least part of the support material (1) having a normal or a lower temperature and adheres as a film (F) to such support material, and the volatizable agent (4) is released in a controlled way by the effects of air and/or heat from the carrier material (2) attached as a film (F),
wherein
the carrier material-agent melt (S) in its molten condition is applied by spraying onto the entire surface or part thereof of the support material (1) having a normal or lower temperature, adheres as the film (F) to the respective surface of the support material (1) as a result of cooling down, or that the carrier material-agent melt (S) solidifies to the film band (F) by applying the molten carrier material (2) to the cold surface of a roller (W1), and the film band (F) is rolled in a passage gap formed by the counter roller (W2) arranged at the same level as roller (W1) and parallel to the latter, onto a band of support material (1) moved through the passage gap.

19. A process in accordance with claim 18, wherein the film (F) is a thin film of up to 3 mm thickness.

20. A process in accordance with claim 18, wherein the support material (1) provided with the film (F) is arranged freely in the room, and the release of the agent (4) is controlled by the ambient air and heat.

21. A process in accordance with claim 18, wherein the release of the volatizable agent (4) from the carrier material (2) is controlled by systematic air and/or heat supply.

22. A process in accordance with claim 21, wherein the systematic air and/or heat supply is performed by at least one electrical means.

23. A process in accordance with claim 22, wherein the at least one electrical means for the air and/or heat supply is arranged within and/or outside of the support material (1) for the film (F).

24. A process in accordance with claim 22, wherein the controlled air supply is achieved with an electrical fan the air flow of which is directed onto the film (F).

25. A process in accordance with claim 22, wherein the electrical means for heat supply is a heating foil and/or a heating wire and/or an infrared radiator and/or an electric light bulb and/or a microwave generator.

26. A process in accordance with claim 18, wherein the carrier material (2) solid at normal temperature is a fatty alcohol or a fatty alcohol-fatty acid mixture.

27. A process in accordance with claim 18, wherein the volatizable agent (4) is a liquid or solid fragrance and/or flavour and/or a liquid or solid insecticide and/or a disinfectant and/or a liquid or solid deodorant and/or a compound and/or mixture of the aforementioned substances.

28. A process in accordance with claim 18, wherein the support material (1) is a flat material consisting of paper, cardboard, plastics, metal, ceramics or glass, a fleece or tissue or a tissue-like product made of textile, glass, ceramics, metal or plastics fibres or a laminate from the aforementioned materials.

29. A process in accordance with claim 18, wherein the support material (1) is a part manufactured by moulding or forming or a part (T) of any shape joined from different elements.
